(19) United States
(12) Patent Application Publication
(10) Pub. No.: US 2023/0347774 A1
(43) Pub. Date: Nov. 2, 2023

(54) CHARGING POLE

(71) Applicant: ME ENERGY GMBH, Wildau (DE)

(72) Inventors: Alexander SOHL, Berlin (DE); Inès ADLER, Berlin (DE)

(73) Assignee: ME ENERGY GMBH, Wildau (DE)

(21) Appl. No.: 18/245,006

(22) PCT Filed: Sep. 6, 2021
(86) PCT No.: PCT/EP2021/074511

§ 371 Date: Mar. 13, 2023

(30) Foreign Application Priority Data
Sep. 11, 2020 (DE) 10 2020 123 801.0

(51) Int. Cl. B60L 53/63; B60L 53/30; B60L 53/50

(52) U.S. Cl. CPC B60L 53/63; B60L 53/305; B60L 53/50; B60L 2240/70

(57) ABSTRACT

The invention relates to a method for generating and delivering electricity from a charging pole into a power grid, having the method steps of receiving a first control command and/or first information, from which a control command is generated, from a data network connected to the charging pole, executing the first control command and/or the control command, generated from the first information, starting the feeding of electrical energy from the charging pole into a power grid and ending the feeding of electrical energy from the charging pole into a power grid, the charging pole being suitable and intended for charging batteries of electric vehicles, and a device for carrying out the method.

The invention relates to a method for generating and delivering electricity from a charging pole into an electricity network, having the method steps of receiving a first control command and/or first information, from which a control command is generated, from a data network connected to the charging pole, executing the first control command and/or the control command, generated from the first information, starting the feeding of electrical energy from the charging pole into an electricity network and ending the feeding of electrical energy from the charging pole into an electricity network, the charging pole being suitable and intended for charging batteries of electric vehicles, and a device for carrying out the method.

### STATE OF THE ART

The spread of electric vehicles powered by an electric motor must be accompanied by a functioning infrastructure for charging electric vehicles. In addition to charging at the household socket, users of electric vehicles must be given the opportunity to obtain energy in public areas. With the currently available ranges of electric vehicles, it is necessary that charging of the vehicles is also possible outside the domestic environment. Therefore, charging stations must be made available in public areas to ensure a constant availability of energy for electric vehicles through a supply network.

Charging poles are known for recharging the traction battery of a plug-in vehicle—hybrid or electric vehicle—as described, for example, in DE 10 2009 016 505 A1. The charging pole itself is connected to a bus bar of the power supply. An existing power grid has a connection element for outputting electrical energy to an electric vehicle.

It is therefore the objective of the present invention to provide a method for charging electric vehicles with which charging is possible at a lower cost.

Furthermore, it is a objective of the present invention to provide a charging pole for charging electric vehicles that can be operated more cost-effectively.

The objective is solved by means of the method for generating and delivering charging current from a charging pole into an electricity grid according to claim 1. Further advantageous embodiments of the invention are set out in the subclaims.

The method according to the invention for generating and dispensing electricity from a charging pole has three process steps: In the first process step, a first control command and/or first information, from which a control command is generated, is received from a data network connected to the charging pole. In the second process step, the feeding of electrical energy from the charging pole into an electricity network is started. Depending on the first control command and/or the first information from which a control command is generated, the electrical energy generated in the charging pole is fed into the electricity grid. In the third process step, the feeding of electrical energy from the charging pole into an electricity grid is terminated. According to the invention, the charging pole is suitable and intended for charging batteries of electrically driven motor vehicles. The first control command and/or the first information from which a control command is generated are suitable and intended for initiating the process of feeding electricity from the charging pole into an electricity network connected to the charging pole.

The method according to the invention is thus carried out with a charging pole intended for charging the batteries of electrically powered motor vehicles. As a rule, the charging process of a motor vehicle has priority over the feeding of electrical energy into a power grid. If the charging pole has an energy surplus, e.g. if an electrically driven motor vehicle requires a lower charging power than the nominal power of the charging pole, the surplus electrical energy generated by the charging pole is fed into the power grid depending on the measured value of the power grid. When the charging pole is idle, i.e. when no vehicle is being charged, electrical energy is fed into the electricity grid depending on the measured value of the power grid. The utilisation of the charging pole is therefore significantly increased by the method according to the invention, the charging pole is in operation more often and thus more cost-effective, and a charging pole operated by the method according to the invention pays for itself in a shorter timescale.

The first control command and/or first information from which a control command is generated is suitable for triggering an action in the charging pole and/or for executing a process, such as feeding electricity from the charging pole into the power grid connected to the charging pole. For the purposes of the present invention, the term power grid refers to a network for the transmission and distribution of electrical energy. It consists of electrical lines such as overhead lines and underground cables and the associated facilities such as switching stations and substations. The power grid is stationary and designed for long-term use; the charging pole is connected to the power grid by means of an electrical connection. The power grid can also be set up only temporarily, e.g. for the temporary operation of a system. In contrast, a power grid in the sense of the invention is not a network for transmitting electrical energy that is connected to the charging pole only for a short time. In particular, power grid in the sense of the invention does not denote an on-board network of an electrically driven motor vehicle. A charging process of such a motor vehicle takes comparatively little time, usually at most up to a few hours.

For the purposes of this disclosure, a charging pole is understood to be a charging device which, due to its compact design, can find space on a narrow pavement or can replace a fuel dispenser at a petrol station, but has a maximum space smaller than the space of a standard car parking space. The charging pole is designed as a column, i.e. it has a height H which is at least 20% greater than its width B and/or depth T. A charging pole within the meaning of the present invention does not have a space which can be entered by a human being. A charging pole is therefore neither a container nor a building. Rather, the charging poles according to the invention has a very compact design in which the structure is adapted to the designated space and not—as in container solutions, for example—the standard size of the enclosure dictates the external dimensions. In the charging pole according to the invention, the ratio of the volume V_{N} used by components and/or the air ducting for cooling to the enclosed volume V_{G} is therefore 0.8 or more (V_{N}/V_{G}>0.8), preferably 0.85 (V_{N}/V_{G}>0.85) or more and particularly preferably 0.9 or more (V_{N}/V_{G}>0.9). The maximum dimensions of the charging pole according to the invention are a length of 5 m, preferably of 4.5 m particularly preferably of 3 m with a width of maximum 2.5 m, preferably of 2.25 m, particularly preferably of 2 m. The height is a maximum of 3 m, preferably 2.5 m, particularly preferably 2.25 m.

In a further embodiment of the invention, the charging pole is suitable and intended for charging electric vehicles with a charging power of >75 kW, preferably >100 kW and particularly preferably >125 kW. The charging of an electric vehicle is thus carried out with a charging power>50 kW, preferably >100 kW and particularly preferably >125 kW. This has the advantage that electric vehicles can be charged quickly and only require a short time at the charging pole.

In another embodiment of the invention, an energy conversion process is started. Depending on the design of the charging pole, an energy conversion requires a lead time in order to be able to generate maximum power during a charging process. For example, the lead time of an energy conversion from light to electricity by e.g. a solar cell is shorter than the lead time of an energy conversion of a liquid and/or gaseous energy carrier by e.g. an internal combustion engine. By suitable selection of the start time of an energy conversion by means of a combustion engine, the charging process for a user is significantly reduced. Optionally, a conversion of direct current into alternating current can be provided before feeding into the power grid.

In another embodiment of the invention, an energy conversion process is terminated. The energy conversion device is stopped and the charging pole is switched to a standby mode. The charging pole therefore does not generate any electrical energy.

In an advantageous embodiment of the invention, receiving the first control command and/or the first information from which a control command is generated and starting the feed-in of electrical energy from the charging pole into a power grid are causally related. The feeding of electrical energy into the power grid takes place when, for example, a control command and/or first information from which a control command is generated is sent to the charging pole from a central server. The method according to the invention thus generates an additional benefit compared to exclusively charging electrically driven motor vehicles, in that additional revenue is generated and/or costs are saved.

In another embodiment of the invention, the first control command and/or the control command generated from the first information starts the feeding of electricity from the charging pole into the power grid connected to the charging pole. Depending on the first control command and/or the control command generated from the first information, the control command controls a start of a feed-in of electrical energy into the power grid. In addition, the amount of electrical energy generated by the charging pole is controlled when, for example, the energy storage of an electrically driven motor vehicle is charged. The amount of electrical energy fed into the power grid is also regulated by the control command.

In a further embodiment of the invention, the first control command and/or the control command generated from the first information starts the energy conversion process. The energy conversion can be performed, for example, by photovoltaics, conversion of wind power, a fuel cell and/or an internal combustion engine with a connected generator. Furthermore, energy conversion in the sense of this patent specification is also understood to mean the conversion of direct current into alternating current or vice versa. The energy conversion starts with the control command.

In an advantageous further embodiment of the invention, the energy conversion takes place in the charging pole. The charging pole is thus very compact, can be operated autonomously and requires little space for installation. A housing protects the components arranged in the charging pole, in particular the device for energy conversion, from the effects of weather and vandalism.

In another embodiment of the invention, a second control command and/or second information from which a control command is generated is received. The second control command and/or the second information from which a control command is generated has also been sent to the charging pole from a central server.

In a further embodiment of the invention, receiving the second control command and/or the second information from which a control command is generated and terminating the supply of electrical energy from the charging pole to a power grid are causally related. The termination of the supply of electrical energy to the electricity grid occurs when such a command or such information is sent from a central server to the charging pole. The central server itself is linked to a measuring device or an information source that provides information about power grid fluctuations to the central server. The central server uses this information to decide whether it makes sense to feed electricity from the charging pole into the power grid connected to the charging pole and then triggers the feed at the charging pole. The central server can also control a large number of charging points and thus initiate the feed-in of electricity from several charging poles at the same time.

In a further embodiment of the invention, the second control command and/or the second information from which a control command is generated terminates the feeding of electrical energy from the charging pole into the power grid connected to the charging pole. The control command controls the termination of a feed-in of electrical energy into the power grid. The termination occurs, for example, when an electric motor vehicle is being charged whose charging process reaches the nominal power of the charging pole or when the utilisation of the power grid and thus the electricity price is low.

In a further embodiment of the invention, the control command terminates the energy conversion process. The energy conversion can be performed, for example, by photovoltaics, conversion of wind power, a fuel cell and/or an internal combustion engine with a connected generator. The energy conversion terminates with the control command.

In a further embodiment of the invention, the amount of energy delivered by the charging pole to the power grid connected to the charging pole is recorded by a measuring device. The information about this is forwarded to the central server via a communication unit in the charging pole.

In a further embodiment according to the invention, the feeding of electricity from the charging pole to an power grid connected thereto is started, carried out and/or terminated by a feeding device.

The objective is also solved by means of the charging pole according to claim 14. Further embodiments of the invention are described in the subclaims following claim 14.

The charging pole according to the invention has a first connection which is suitable and intended for delivering electrical energy to an electric vehicle. The first connection has one or more charging cables which can be connected to an electric motor vehicle and via which the charging of the electric motor vehicle takes place. Optionally, the first connection has a charging socket to which a charging cable for charging electric vehicles can be connected.

Furthermore, the charging pole according to the invention comprises a second connection suitable and intended for delivering electrical energy to a power grid connected to the charging pole. The second connection is connected to a feed-in point of a power grid.

According to the invention, the charging pole comprises a communication device suitable and intended for receiving a first control command and/or a first information from which a control command is generated. The first control command and/or first information from which a control command is generated is sent by a server that is connected to the charging pole via a communication network. The server can also be configured as a central server for the control of several charging poles.

In a further embodiment of the invention, the charging pole is suitable and intended for charging electric vehicles with a charging power of >75 kW, preferably >100 kW and particularly preferably >125 kW. The charging of an electric vehicle is thus carried out with a charging power>50 kW, preferably >100 kW and particularly preferably >125 kW. This has the advantage that electric vehicles can be charged quickly and only require a short time at the charging pole.

In another embodiment of the invention, the charging pole comprises a controller adapted and arranged to execute the first control command and/or the control command generated from the first information.

In a further embodiment of the invention, the charging pole comprises a feeding device suitable and intended for starting, performing and/or terminating feeding operations for feeding electricity from the charging pole into the power grid connected to the charging pole.

In a further embodiment of the invention, the charging pole comprises a measuring device which is suitable and intended for measuring the amount of electrical energy delivered to the power grid connected to the charging pole during a feed-in process and for forwarding the measurement data to the control system of the charging pole.

In an advantageous further development of the invention, the first connection is structurally different from the second connection. The second connection is used to feed electrical energy into a motor vehicle to be charged, while the first connection is used to feed electrical energy into a power grid. Both feed-in processes usually require different electrical power due to different current strengths, current voltages and possibly different phases. For example, a motor vehicle to be charged is preferably charged with direct current at 400 V with a maximum power of, for example, 150 kW, while a conventional domestic power grid is operated with alternating current (50 Hz) at 230 V with 16 A. These differences require a different structural design of the respective connections.

In a further embodiment of the invention, the charging pole has a device for energy conversion. The energy conversion can be carried out, for example, by photovoltaics, conversion of wind power, a fuel cell and/or an internal combustion engine with connected generator. The energy conversion device is located in the charging pole itself. The charging pole is therefore very compact, can be operated autonomously and requires little space for installation. A housing protects the components arranged in the charging pole, in particular the energy conversion device, from the effects of weather and vandalism.

In a further embodiment of the invention, the energy conversion device is suitable and intended for converting a gaseous and/or liquid energy carrier into electrical energy. The energy conversion can be carried out, for example, by a fuel cell and/or an internal combustion engine with connected generator. A fuel cell can be operated with (gaseous) hydrogen or a liquid hydrogen carrier, e.g. methanol. An internal combustion engine can also be operated with methanol, hydrogen or conventional petrol or diesel fuel, for example. All of the fuels mentioned are commonly available, can be stored safely and can also be produced in a climate-neutral process.

In another embodiment of the invention, the charging pole comprises an energy storage device. The energy storage device stores the fuel that is used as the primary energy source in the charging pole. The energy storage is preferably designed for liquid fuels (e.g. petrol, diesel fuel, methanol), but can also be designed for gaseous fuels, e.g. hydrogen.

In a further embodiment of the invention, the energy storage device is a tank suitable and intended to contain a liquid and/or gaseous energy carrier. The tank stores the fuel that is used as the primary energy source in the charging pole. The tank is preferably designed for liquid fuels (e.g. petrol, diesel fuel, methanol), but can also be designed for gaseous fuels, e.g. hydrogen.

Examples of embodiments of the method for charging electric vehicles according to the invention and of the charging pole according to the invention are shown schematically in simplified form in the drawings and are explained in more detail in the following description.

### SHOWING

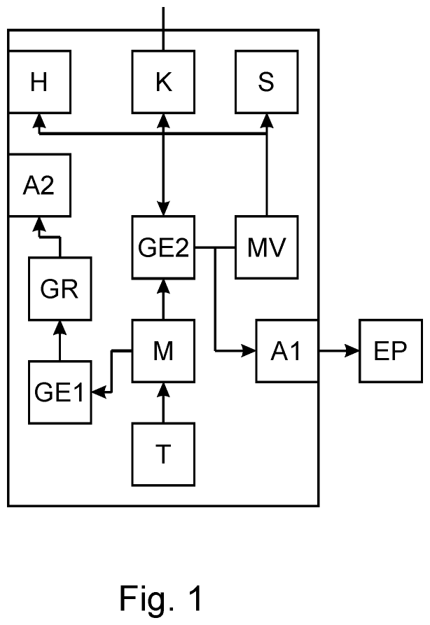

FIG. 1: An embodiment of a charging pole according tot he invention

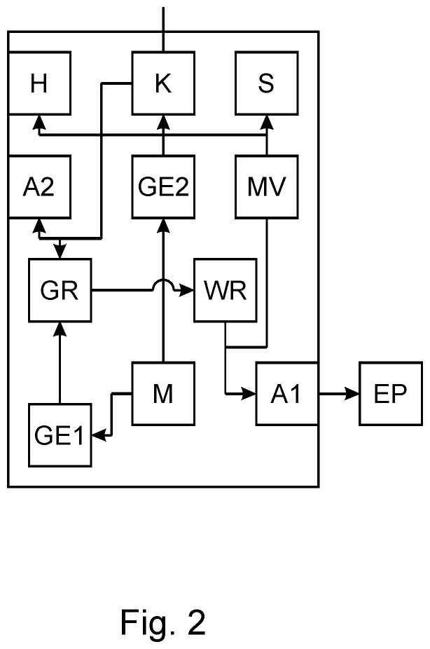

FIG. 2: A further embodiment of a charging pole according tot he invention

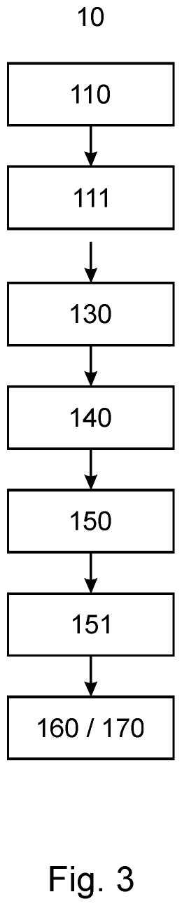

FIG. 3: An example embodiment of the method according to the invention for generating and delivering electricity by means of the charging pole according to the invention

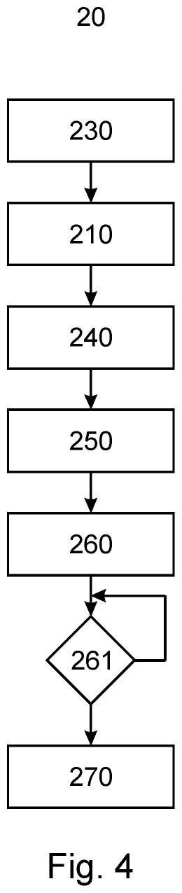

FIG. 4: A further example embodiment of the method according to the invention for generating and delivering electricity by means of the charging pole according to the invention with simultaneous charging of an electric motor vehicle

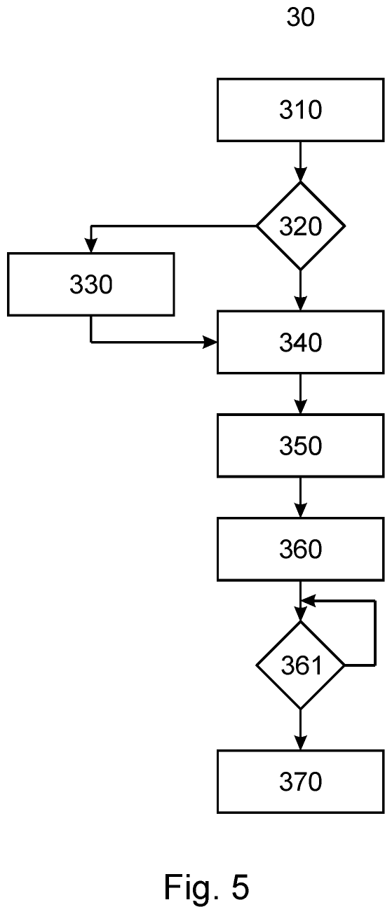

FIG. 5: A further example embodiment of the method according to the invention for generating and delivering electricity by means of the charging pole according to the invention with simultaneous charging of an electric motor vehicle

An embodiment of the charging pole 1 according to the invention is shown in FIG. 1. In this embodiment, the charging pole 1 has an internal combustion engine M for energy conversion. The combustion engine M is usually a piston combustion engine, but other designs such as a Wankel engine or turbine are also possible. Advantageously, the internal combustion engine M is preferably operated with methanol or ethanol or a mixture of methanol and ethanol. Both types of fuel can be produced from biomass in an environmentally friendly way, have been established as fuels worldwide for a long time and are therefore available at low cost. Their transport and storage as well as their operation in internal combustion engines are comparable to conventional petrol (for motor vehicles) and thus unproblematic. The storage of the fuel in the charging pole 1 according to the invention takes place in an energy storage device (tank) T. The charging pole also has a compact design and finds a place on a footpath next to the edge of the roadway. The dimensions of the charging pole are 1.5 m×1.0 m.

The combustion engine M drives the first generator GE1 by rotation. The kinetic energy generated by the combustion engine M is thus converted into electrical energy, into an alternating current, by the first generator GE1. The alternating current generated by the first generator GE1 is converted into a direct current in the rectifier GR, which is fed to the connection device A2. In this embodiment example, the first generator GE1 generates a charging current for an electric motor vehicle to be charged with a voltage of 400 V and a maximum power of 200 kW.

The connection device A2 has one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current based on this data. The combustion engine M also drives a second generator GE2 by rotation. The second generator GE2 supplies the control unit S, the communication unit K and the HMI unit H with electrical energy for operation.

In contrast to the first generator GE1, the second generator produces an alternating current with a frequency of 50 Hz, a current strength of 16 A at a voltage of 230 V. The electric current generated by the second generator GE2 can therefore be fed directly into a domestic power grid. The electric current generated by the second generator GE2 is fed in via the connection device A1, which is connected to the power grid via the feed-in point EP. The measuring device MV is connected to the control unit S in order to record the amount of energy delivered to the electricity grid connected to the charging pole and to forward it to the control unit.

The HMI unit H has a display and operating device on which the data important to a user, such as charging current, charging time and costs of the charging process, are called up and displayed. In addition, a user can initiate or end the charging process and pay. Various payment systems are possible, e.g. via different credit cards. Other payment systems are also possible, e.g. via a mobile terminal (smartphone). The charging pole 1 is connected to the operator of the charging pole 1 and a plurality of charging poles via the communication unit K, which establishes an internet connection, e.g. with a management system or alternatively with a cloud storage. In particular, the communication unit is connected to a central server, which in turn is connected to a measuring device for monitoring the electricity grid connected to the charging pole and/or has information as to whether it is necessary or economical to feed electricity from the charging pole into the electricity grid. In this case, the central server sends a first control command and/or first information, from which a control command is generated, to the charging pole. All the aforementioned components of the charging pole 1 are advantageously arranged in the charging pole 1 itself. For this purpose, the charging pole 1 has a housing that protects the components inside the charging pole 1 from the effects of the weather and damage.

FIG. 2 shows a further embodiment of the charging pole 1 according to the invention. The charging pole 1 does not have an energy storage for the fuel, the fuel as the primary energy source of the charging pole 1 is supplied to the charging pole 1 via a line. An embodiment example of the charging pole 1 according to the invention is shown in FIG. 1. In this embodiment example, the charging pole 1 has an internal combustion engine M for energy conversion. The combustion engine M is usually a piston combustion engine, but other designs such as a Wankel engine or turbine are also possible. Advantageously, the internal combustion engine M is preferably operated with methanol or ethanol or a mixture of methanol and ethanol. Both types of fuel can be produced from biomass in an environmentally friendly way, have been established as fuels worldwide for a long time and are therefore available at low cost. Their transport and storage as well as their operation in internal combustion engines are comparable to conventional petrol (for motor vehicles) and thus unproblematic. In this embodiment, fuel is supplied via a fuel line (not shown). Furthermore, the charging pole has a width of 1.7 m and a length of 3.8 m and can thus be erected in any car park to supply the electric vehicles parked in the surrounding car parks.

The combustion engine M drives the first generator GE1 by rotation. The kinetic energy generated by the combustion engine M is thus converted into electrical energy, into an alternating current, by the first generator GE1. The alternating current generated by the first generator GE1 is converted into a direct current in the rectifier GR, which is fed to the connection device A2. In this embodiment example, the first generator GE1 generates a charging current for an electric motor vehicle to be charged with a voltage of 400 V and a maximum power of 200 kW.

The connection device A2 has one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current based on this data. The electric current is fed in from the first generator via the connection device A1, which is connected to the power grid via the feed point EP. The measuring device MV is connected to the control unit S and the line to the first connection. It is used to record the amount of energy delivered by the charging pole to the power grid. Optionally, a rectifier GR may be provided, which is connected to an inverter WR that converts the direct current generated in the rectifier GR into an alternating current with a frequency of 50 Hz, a current intensity of 16 A at a voltage of 230 V. The rectifier GR is connected to the inverter WR. The electric current generated by the first generator GE1 can therefore be fed directly into a domestic power grid. In this case, the electric current is fed in via the connection device A1, which is connected to the power grid via the feed-in point EP.

The combustion engine M also drives a second generator GE2 by rotation. The second generator GE2 supplies the control unit S, the communication unit K and the HMI unit H with electrical energy for operation. The HMI unit H has a display and operating device on which the data important for a user, such as charging current, charging duration and cost of the charging process, are retrieved and displayed. In addition, a user can initiate or end the charging process and pay. Various payment systems are possible, e.g. via different credit cards. Other payment systems are also possible, e.g. via a mobile terminal (smartphone). The charging pole 1 is connected to the operator of the charging pole 1 and a plurality of charging poles via the communication unit K, which establishes an internet connection, e.g. with a central server and/or management system or alternatively with a cloud storage.

An embodiment of the method 10 according to the invention is shown in FIG. 3. In this embodiment, no electrically powered motor vehicle is charged, the charging pole 1 only feeds electrical energy into a power grid. The method according to the invention starts with the reception of a first information from a central server in the communication unit K of the charging pole 1. The controller S generates a control command 111 for starting the energy conversion from the first information. The energy conversion starts 130 by starting the motor M that drives the generator GE2. The electric current generated in the charging pole 1 is fed into the power grid 140 via connection A1 and the feed device contained therein.

In the next method step 150, a second information is received at the communication unit from the central server. The control unit S generates a control command for terminating the energy conversion from the second information. If no second information is received, the energy conversion and the feeding of electrical energy into the power grid is continued.

When the control command is executed, the feed is terminated 160 by stopping the motor M that drives the generator GE2. Likewise, the energy conversion 170 stops. The process 10 according to the invention is terminated here, the charging pole 1 is set to a standby mode, the acquisition of a first measured value 110 of the amount of energy delivered by means of the measuring device MV is carried out during the feeding.

FIG. 4 shows a further embodiment example of the process 20 according to the invention, in which the charging pole 1 is already charging the energy storage of an electrically driven motor vehicle. The method 20 starts with the start of the energy conversion 230 for charging an electric vehicle, which is supplied with electrical energy via the charging cable connected to the second connection A2. Then, a first control command is received from a central server by means of the communication unit K. The control unit S executes the first control command and starts feeding electricity into the power grid connected to the charging pole. The charging process of the electric vehicle continues.

In the next step 250, a second control command is received by means of the communication unit K. The control unit S executes the second control command to stop feeding electrical energy into the power grid. The controller S executes the second control command to stop the supply of electrical energy to the power grid: The feed-in is terminated 260. As long as no second control command is received from the central server, the feed-in of electrical energy into the power grid is continued.

Then the control unit S checks whether a charging process of a motor vehicle can be completed 261, i.e. whether the battery of the electric motor vehicle is charged or whether a user has completed the charging process. If the charging process of a motor vehicle is completed, the energy conversion is terminated 270. The process 20 according to the invention is terminated here, the charging pole 1 is set to a standby mode, the acquisition of a first measured value 210 of the power grid by means of the measuring device MV is carried out. If the check 261 shows that the charging process of a motor vehicle has not ended, the method 20 continues with the check of the continuation of the charging process 210. As long as the charging process has not ended, the energy conversion is also continued.

A variant of the embodiment example illustrated in FIG. 3 of the method 30 according to the invention is shown in FIG. 5. The method 30 according to the invention starts with the reception of a first control command 310 by means of the communication unit K. The first control command 310 is received by the communication unit K.

A query 320 is then made as to whether the energy conversion is already in operation, i.e. the motor M has already started and is driving the generators GE1 and GE2 in order to charge an electric motor vehicle. If the energy conversion is already active, the control unit S executes the first control command and starts feeding the electrical energy generated by the charging pole into the power grid connected to the charging pole. If the energy conversion is not active, i.e. the motor M is not started, the energy conversion is started 330 by starting the motor M that drives the generator GE2.

In the next method step 350, a second control command is received by means of the communication unit K. The control unit S executes the second control command to terminate the feed.

Then the control unit S checks whether a charging process of a motor vehicle can be completed 361, i.e. whether the battery of the electric motor vehicle is charged or whether a user has completed the charging process. If the charging process of a motor vehicle has ended, the energy conversion is terminated 370. The process 30 according to the invention is terminated here, the charging pole 1 is set to a standby mode, the amount of energy fed into the power grid detected by the measuring device MV is transmitted to the control unit. If the check 361 shows that the charging process of a motor vehicle has not ended, the process 20 is continued until the charging process has ended and the energy conversion is also stopped.

### REFERENCE LIST

1 Charging pole
H HMlunit
S Control unit
K Communication unit
GW DC-DC converter
GE1 Generator 1
GE2 Generator 2
M Combustion engine
A1 First connection device for charging cable
A2 Second connection device for charging cable
T Tank unit
WR Inverter
MV Device for detecting a measured value
EP Feed-in point
G Housing
10, 20, 30 Method for generating and delivering electricity from a charging pole
110, 210, 310 Receiving a first control command and/or a first information
111, 211, 321 Generating a first control command
320 Review Energy Conversion
130, 230, 330 Start energy conversion
140, 240, 340 Feeding into the power grid
150, 250, 350 Receiving a second control command and/or a second information
151, 251, 351 Generating a second control command
160, 260, 360 Termination of feed-in of electric energy
261, 361 Checking the charging process of an electric vehicle
170, 270, 370 Termination of energy conversion

1. A process for generating and delivering electricity (100) from a charging pole (1) into a power grid comprising the following steps
Receiving a first control command and/or first information, from which a control command is generated, from a data network connected to the charging pole,
Execute the first control command and/or the control command generated from the first information,
Start of the feed-in of electrical energy from the charging pole into a power grid, and
Termination of the feed-in of electrical energy from the charging pole into a power grid,
where the charging pole is suitable and intended for charging batteries of electric vehicles.

2. A process for generating and delivering electricity (100) from a charging pole (1) into a power grid according to claim 1,
characterised in that
a process for energy conversion is started.

3. A process for generating and delivering electricity (100) from a charging pole (1) into a power grid according to claim 1,
characterised in that
a process for energy conversion is terminated.

4. A process for generating and delivering electricity (100) from a charging pole (1) into a power grid according to claim 1,
characterised in that
the receiving of a first control command and/or a first information from which a control command is generated and the starting of the feeding of electrical energy from the charging pole into a power grid are causally related.

5. A process for generating and delivering electricity (100) from a charging pole (1) into a power grid according to claim 4,
characterised in that
the first control command and/or the control command generated from the first information starts the feed-in of electricity from the charging pole into the power grid connected to the charging pole.

6. A process for generating and delivering electricity (100) from a charging pole (1) into a power grid according to claim 4,
characterised in that
the control command starts the energy conversion process.

7. A process for generating and delivering electricity (100) from a charging pole (1) into a power grid according to claim 1,
characterised in that
the energy conversion takes place in the charging station.

8. A process for generating and delivering electricity (100) from a charging pole (1) into a power grid according to claim 1,
characterised in that
a second control command and/or second information from which a control command is generated is received from a data network connected to the charging pole.

9. A process for generating and delivering electricity (100) from a charging pole (1) into a power grid according to claim 8
characterised in that
the receipt of the second control command and/or the second information and the termination of the feed-in of electrical energy from the charging pole into a power grid are causally related.

10. A process for generating and delivering electricity (100) from a charging pole (1) into a power grid according to claim 8
characterised in that
the second control command and/or the control command generated from the second information terminates the feeding of electricity from the charging pole into the power grid connected to the charging pole.

11. A process for generating and delivering electricity (100) from a charging pole (1) into a power grid according to claim 1
characterised in that
the second control command and/or the control command generated from the second information terminates the energy conversion process.

12. A process for generating and delivering electricity (100) from a charging pole (1) into a power grid according to claim 1,
characterised in that
the amount of energy delivered to the power grid is recorded by a measuring device.

13. A process for generating and delivering electricity (100) from a charging pole (1) into a power grid according to claim 1,
characterised in that
the feeding of electricity from the charging pole into the power grid connected to the charging pole is started and/or stopped by a feeding device.

14. Charging pole (1) suitable and intended for charging batteries of electric vehicles, wherein the charging pole (1)
comprises a first connection suitable and intended for delivering electrical energy to an electric vehicle,
comprises a second connection suitable and intended for delivering electrical energy to a power grid connected to the charging pole (1),
characterised in that
the charging pole (1) comprises communication means suitable and intended for receiving a first control command and/or a first information from which a control command is generated.

15. Charging pole (1) according to claim 14
characterised in that
the charging pole comprises a controller suitable and intended for executing the first control command and/or the control command generated from the first information.

16. Charging pole (1) according to claim 15
characterised in that
the control unit controls a feed-in device,
wherein the feeding device comprises a switching device suitable and intended for starting and/or terminating feeding operations.

17. (canceled)

18. Charging pole (1) according to claim 14,
characterised in that
the charging pole comprises a measuring device suitable for and intended to measure the amount of energy delivered to the power grid connected to the charging pole during a feed-in operation.

19. Charging pole (1) according to claim 14,
characterised in that
the first connection is structurally different from the second connection.

20. Charging pole (1) according to claim 14,
characterised in that
the charging pole has a device for energy conversion,
wherein the energy conversion device is suitable and intended for converting a gaseous and/or liquid energy carrier into electric energy.

21. (canceled)

22. Charging pole (1) according to claim 14,
haracterized in that
the charging pole has an energy storage device,
wherein the energy storage device is a tank suitable and intended to contain a liquid and/or gaseous energy carrier.

23. (canceled)
